(19) United States
(12) Patent Application Publication
(10) Pub. No.: US 2007/0118234 A1
(43) Pub. Date: May 24, 2007

(54) APPARATUS AND METHOD OF DISPLAYING A SYMMETRIC-TYPE MENU

(75) Inventors: Kuan-Hong Hsieh, Shenzhen (CN); Han-Che Wang, Shenzhen (CN); Xiao-Guang Li, Shenzhen (CN); Wen-Chuan Lian, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,383

(22) Filed: Aug. 3, 2006

(30) Foreign Application Priority Data
Sep. 21, 2005 (CN) 200510037464.0

(51) Int. Cl. G05B 11/01

(52) U.S. Cl. 700/17

(57) ABSTRACT

A display apparatus for displaying a symmetric-type menu is provided. The display apparatus includes a screen and a frame connecting to the screen. The screen has a breadthwise menu region and a lengthwise menu region. The menu in the lengthwise menu region is a sub-menu of a menu option of the menu in the breadthwise menu region. The frame has a breadthwise touch strip and a lengthwise touch strip. Each touch strip allows one to select a desired menu option to perform an associated function therewith, and each touch strip maps to a corresponding menu region. A method is also provided.

### TECHNICAL FIELD

The present invention relates to a display apparatus and display method therefor, and particularly to a display apparatus and method of displaying a symmetric-type menu.

### GENERAL BACKGROUND

Generally, a display apparatus is a device to visually output information including texts and graphics on a screen. It is widely and increasingly used in electronic devices. A first conventional display apparatus includes a screen to display data (i.e., an image) thereon, and a frame to support the screen. The frame is further disposed a plurality of mechanical function buttons thereon to input selections and actuate any desired function. The more functions the display apparatus has, the more mechanical function buttons the frame is disposed thereon. Therefore, the frame should be designed larger than needed so as to hold the mechanical function buttons. As a result, a volume of the display apparatus as a whole becomes larger, and an overall appearance of the whole display apparatus looks untidy.

A second conventional display apparatus adopts a touch screen instead of mechanical buttons for input selections. The touch screen uses a graphical user interface (GUI) displayed on the display screen thereof buttons, allowing to touch by the finger or the like for making a selection. However, by directly touching the display screen, the touch screen thereupon is easily scratched or damaged.

Therefore, there is a need for an improved display apparatus and touch-based method therefore that can overcome the above-mentioned problems.

### SUMMARY

A touch-based display apparatus is provided. The display apparatus is capable of displaying a symmetric-type menu. The display apparatus includes a screen and a frame. The screen has a breadthwise menu region and a lengthwise menu region. Each menu region displays a menu therein. The menu in the lengthwise menu region is a sub-menu of a menu option of the menu in the breadthwise menu region. The frame connects to the screen and has a breadthwise touch strip and a lengthwise touch strip thereof. Each touch strip corresponds to one of the menu region, and allows to select a desired menu option to perform an associated function therewith.

A touch-based method enabling a display apparatus to display a symmetric-type menu is also provided. The method includes the steps of: (a) providing a display apparatus having a screen and a frame connecting to the screen, the screen having a breadthwise menu region and a lengthwise menu region, and the frame having a breadthwise touch strip and a lengthwise touch strip each corresponding to one of the menu regions; (b) receiving and processing any sensing signal from one of the touch strips; (c) displaying a symmetric-type menu in the menu region; (d) hiding at least one of menu options displayed in the breadthwise menu region and replacing at least one of the displayed menu options by another hidden menu option and displaying a sub-menu of the menu option which moves in the lengthwise menu region, when receiving a plurality of sensing signals from the breadthwise touch strip; (e) hiding at least one of menu options displayed in the lengthwise menu region and replacing at least one of the displayed menu options by another hidden menu option, when receiving a plurality of sensing signals from the lengthwise touch strip; and (f) performing a function associated with a selected menu option when receiving a sensing signal from the lengthwise touch strip.

Other advantages and novel features will be drawn from the following detailed description with reference to the attached drawings, in which:

### BRIEF DESCRIPTION OF THE DRAWINGS

FIG. 1 is an exemplary schematic diagram of a touch-based display apparatus enabling to display a symmetric-type menu in accordance with a preferred embodiment of the present invention, the display apparatus including a screen and a frame, the frame having a breadthwise touch strip and a lengthwise touch strip thereof;

FIG. 2 is a block diagram representing a hardware infrastructure of a sensing signal processing circuit for a touch sensitive unit beneath the touch strips of FIG. 1 with the signal processing circuit connecting to a processing unit;

FIGS. 3A-3C illustrate a series of symmetric-type menus involving different menu options displayed in a breadthwise menu region and a lengthwise menu region of the screen of FIG. 1 in accordance with a preferred embodiment of the present invention, each menu region corresponding to a touch strip of FIG. 1; and

FIG. 4 is a flowchart of a preferred touch-based method for enabling a display apparatus of FIG. 1 to display a symmetric-type menu in accordance with a preferred embodiment of the present invention.

### DETAILED DESCRIPTION OF THE EMBODIMENTS

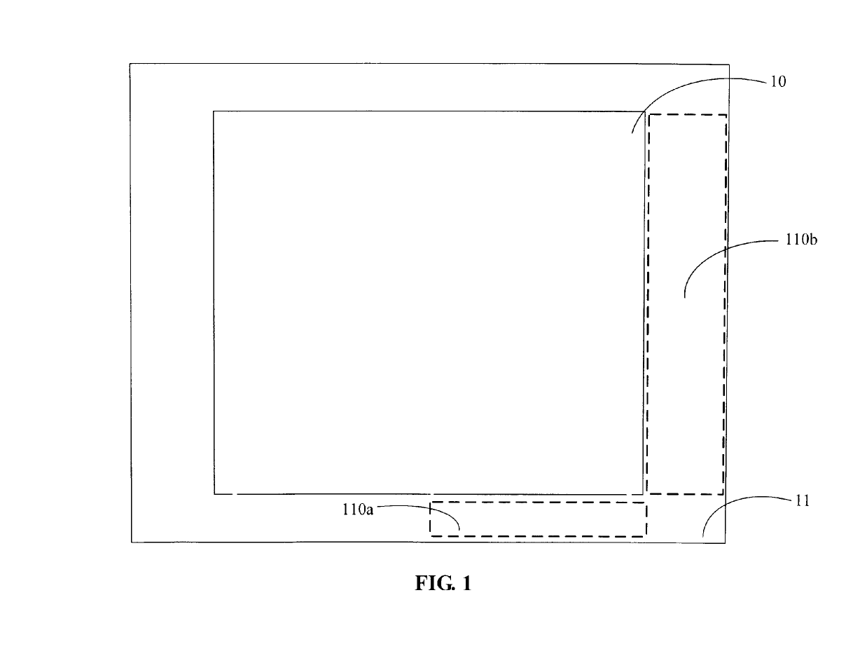

FIG. 1 is an exemplary schematic diagram of a touch-based display apparatus enabling to display a symmetric-type menu in accordance with a preferred embodiment of the present invention. The display apparatus includes a screen 10 and a frame 11. The screen 10 has a breadthwise menu region 100 and a lengthwise menu region 101 each for displaying a menu therein. The menu contains a number of menu options, furthermore, some of the menu options may be hidden due to a limited space of the screen 10. In addition, due to a symmetric relationship between the breadthwise menu region 100 and the lengthwise menu region 101, the menus displayed in the menu regions thereupon forms a symmetric-type menu. The frame 11 includes a breadthwise touch strip 110a and a lengthwise touch strip 110b thereon selectable by contact to perform a particular function associated with the menu regions.

For example, a contact on any of the touch strips initiates the symmetric-type menu to be displayed in the menu regions. After initiating the symmetric-type menu, a further contact on the breadthwise touch strip 110a controls a selection of a desired menu option of the menu displayed in the breadthwise menu region 100. That is, a stroke on the breadthwise touch strip 110a hides the currently displayed but now undesired menu options out of the breadthwise menu region 100 until the desired menu option rotates or moves into the lengthwise menu region 101, thereby displaying a sub-menu of the desired menu option. Alternatively, a further contact on the lengthwise touch strip 110b controls a selection of a desired menu option of the menu displayed in the lengthwise menu region 101. That is, a stroke on the lengthwise touch strip 110b hides the currently displayed but now undesired menu options out of the lengthwise menu region 101 until the hidden but desired menu options appears in the lengthwise menu region 101. When the desired menu option appears, a further touch on a corresponding location of the lengthwise touch strip 110b performs the function associated with the menu option such as, for example, displaying a sub-menu of the menu option, executing a particular operation indicated by the menu option, etc.

In order to provide a friendly and easy user interface, each touch strip is designed to correspond to one of the menu regions parallel to it, that is, the breadthwise touch strip 110a corresponds to the breadthwise menu region 100 and the lengthwise touch strip 110b corresponds to the lengthwise menu region 101. Preferably, a length of each touch strip is designed to correspond to a length of the corresponding menu region. Furthermore, each touch strip has a plurality of touch sensitive units (not shown) beneath thereof. Each touch sensitive unit is constructed to essentially map to a menu option of the menus. That is, each touch sensitive unit is designed to perform a function associated with the menu option. Moreover, each touch sensitive unit includes a sensing signal processing circuit 112 (described in more detail below) for generating sensing signals to perform the function associated with the menu option in response to a contact on a corresponding location of the touch strip. Each touch sensitive unit beneath the touch strip is further assigned a coordinate for identification.

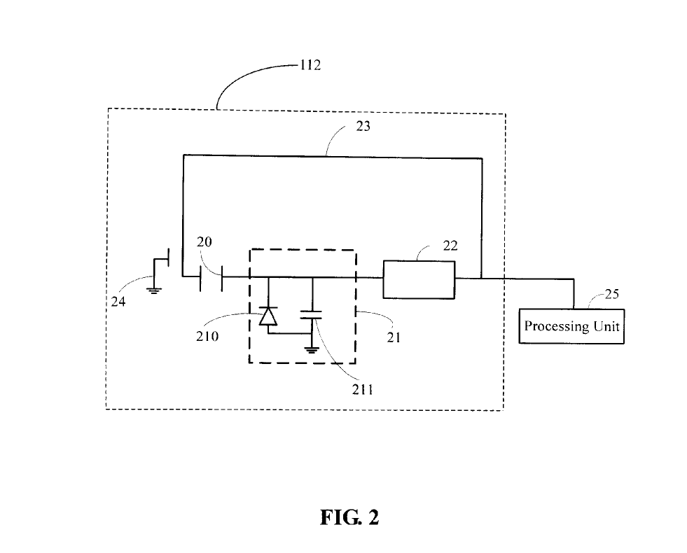

The display apparatus further includes a processing unit 25 as shown in FIG. 2. The processing unit 25 receives and processes the sensing signals from the touch sensitive units beneath the touch strips according to assigned coordinates therewith, and performs corresponding functions. For example, in response to a single sensing signal from the touch strips (i.e., the breadthwise touch strip 110a or the lengthwise touch strip 110b), the processing unit 25 processes the sensing signal, and initiates to display the symmetric-type menu last displayed thereon in the menu regions. That is, the processing unit 25 respectively displays the menu and its associated sub-menu in the breadthwise menu region 100 and the lengthwise menu region 101.

In response to a plurality of sensing signals from the breadthwise touch strip 110a while the symmetric-type menu is in display, the processing unit 25 hides at least one of the menu options displayed in the breadthwise menu region 100 and replaces the at least one of the displayed menu options by one of the hidden menu options, and further displays the sub-menu of a selected menu option which rotates or moves into the lengthwise menu region 101. Furthermore, the processing unit 25 displays the selected menu option in a particular location (e.g., a location labeled as 102) of the screen 10.

In response to a plurality of sensing signals from the lengthwise touch strip 110b while the symmetric-type menu is in display, the processing unit 25 hides at least one of the menu options displayed in the lengthwise menu region 101 and replaces the at least one of the displayed menu options by one of the hidden menu options.

In response to a sensing signal from the lengthwise touch strip 110b while the symmetric-type menu is in display, the processing unit 25 performs the function indicated by the selected menu option in the lengthwise menu region 101. In addition, when the menu option has a sub-menu, the processing unit 25 further displays the sub-menu of the menu option in the lengthwise menu region 101, and displays the selected menu option in the particular location 102 of the screen 10.

FIG. 2 is a block diagram of a sensing signal processing circuit 112 for the touch sensitive unit beneath the touch strips of FIG. 1 according to one embodiment of the present invention, wherein the signal processing circuit 112 is in communication with the processing unit 25. The sensing signal processing circuit 112 has an antenna 20, a clamping circuit 21, a detector 22, a feedback line 23, and a grounding line 24. The antenna 20 is electrically coupled to the clamping circuit 21, which itself is electrically coupled to an input end of the detector 22. An output end of the detector 22 is respectively electrically coupled to the processing unit 25 and one end of the feedback line 23. The feedback line 23 forms a positive feedback circuit with the antenna 21. The grounding line 24, which takes a form of a space between two adjacent touch sensitive units, is for spacing the touch sensitive units therebetween.

It is known that the human body is electrically charged with noise and static signals. Therefore, when a user contacts at least one of the touch strips, at least some of the noise and static signals of the user with a desired signal may be received by the antenna 20. The antenna 20 transmits the received noise and static signals to the clamping circuit 21. However, the static electrical signals may cause interference to normal operation of the detector 22, and may even fry the detector 22. In addition, a strong noise may adversely influence a resulting sensing signal for the processing unit 25; that is, the sensitivity of the touch sensitive unit may be diminished, and the quality of the resulting sensing signal may be negatively impacted. Accordingly, the clamping circuit 21 is adapted for eliminating the static signals and for reducing the noise, thus improving the sensitivity accuracy of the touch sensitive unit.

The clamping circuit 21 in one embodiment of the present invention includes a diode 210, and a capacitor 211. The cathode of the diode 210 is electrically coupled to the antenna 20, while the anode is electrically coupled to ground. Upon receiving the noise and static signals with a desired signal, the diode 210 filters out the static signals to ground so as to avoid frying the detector 22, and reducing the noise influencing to the capacitor 211. The capacitor 211 further leaks a portion of the reduced noise to ground. Thus the reduced noise is further weakened, thereby obtaining a more accurate sensitivity.

The detector 22 has a high input impedance, so as to easily detect the desired signal with the reduced and weakened noise received from the input end of the detector 22. The detector 22 then converts the desired signal with the reduced and weakened noise into digital signals, namely the sensing signals, and transmits the sensing signals through the output end of the detector 22 to the processing unit 25 to perform corresponding controls. Furthermore, because the feedback line 23 forms a positive feedback circuit with the antenna 20, the noise generated as the user touches the edge of the touch sensitive unit is filtered, thereby further improving the sensitivity accuracy of the touch sensitive unit.

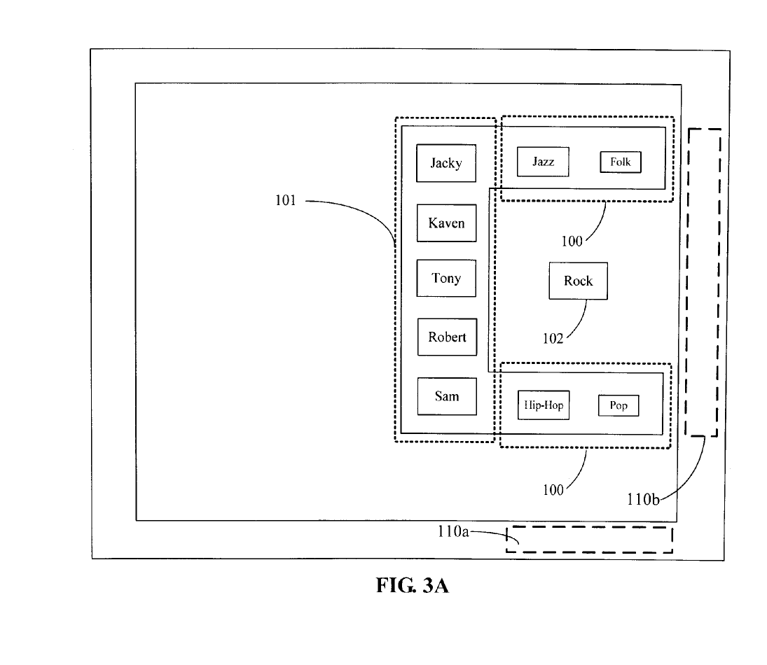

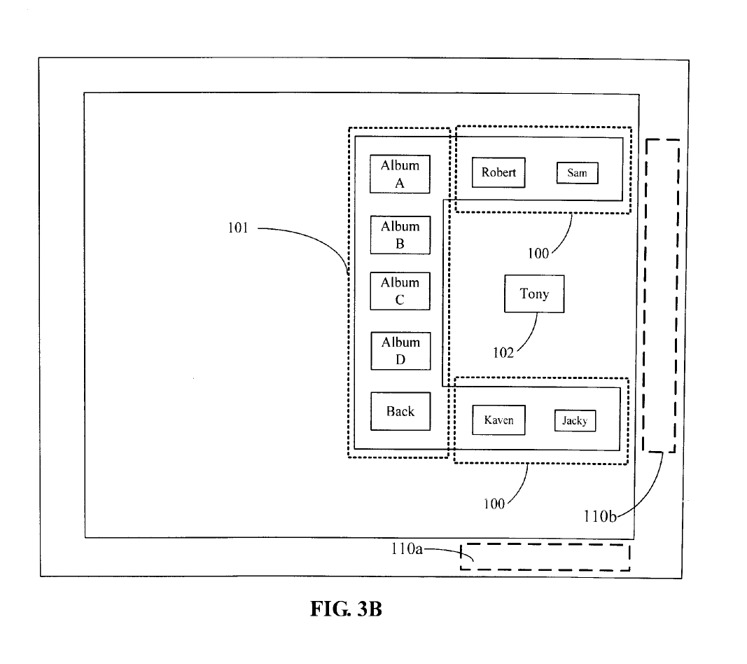

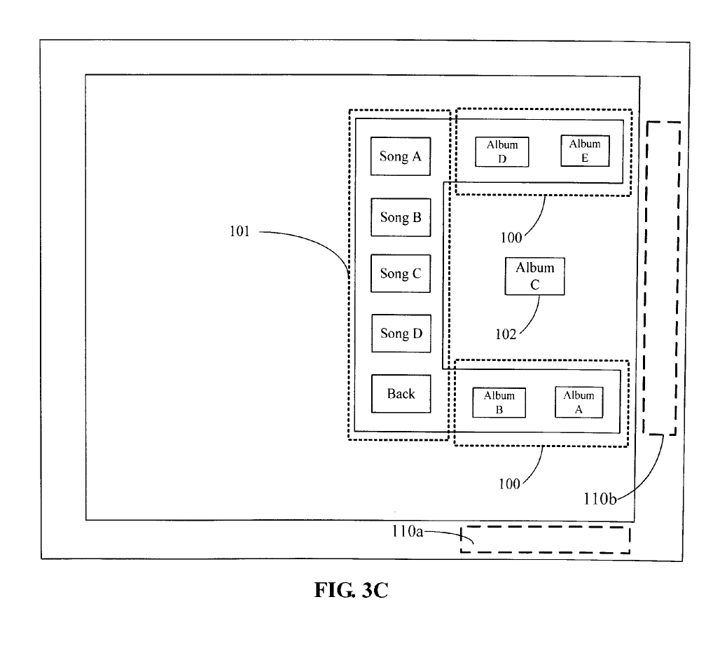

FIGS. 3A-3C illustrate a series of symmetric-type menus having different menu options displayed in menu regions of the screen of FIG. 1 in accordance with a preferred embodiment of the present invention, each menu region corresponding to a touch strip of FIG. 1. As described above, the breadthwise menu region 100 and the lengthwise menu region 101 respectively display the menu and the sub-menu associated therein, thereby forming the symmetric-type menu in the screen 10. In this exemplary embodiment, contents of the menu options provide information related to music, and only three symmetric-type menus are illustrated therein. However, either the contents of the menu options or the number of the symmetric-type menus are not to be construed as being limited thereto.

Each menu region is capable of displaying different parts of the information in different display states. For example, referring to FIG. 3A, where namely a first display state of the screen 10 is shown, the breadthwise menu region 100 displays a menu providing information related to selectable music styles (e.g., Pop, Hip-Hop, Rock, Jazz, Folk, etc.), and the lengthwise menu region 101 displays a sub-menu of a desired music style menu option such as, for example, “Rock”, the sub-menu providing information related to the selectable music style's singers (e.g., Sam, Robert, Tony, Kaven, Jacky, etc.).

Referring to FIG. 3B, where namely a second display state of the screen 10 is shown, the breadthwise menu region 100 displays the menu providing information related to rock music singers, which contents have been displayed as the sub-menu in the first display state, and the lengthwise menu region 101 displays a sub-menu of a desired music singer menu option such as, for example, “Tony”, the sub-menu providing information related to one rock music singer Tony's music albums (e.g., Album A, Album B, Album C, Album D, etc.).

Referring to FIG. 3C, where namely a third display state of the screen 10 is shown, the breadthwise menu region 100 displays the menu providing information related to selectable music albums of one rock music singer Tony, which contents have been displayed as the sub-menu in the second display state, and the lengthwise menu region 101 displays a sub-menu of a desired music album menu option such as, for example, “Album C”, the sub-menu providing information related to specific music names in “Album C” (e.g., Song A, Song B, Song C, Song D, etc.).

In addition, in each display state, the screen 10 displays the selected menu option (i.e., “Rock”, “Tony”, “Album C”) in the particular location 102 such as that shown in FIGS. 3A-3C. Furthermore, the screen 10 can display the selected menu option in an appropriated mode, such as a flashing mode. Moreover, in the described display states except the first display state, each sub-menu further has a “Back” menu option displayed in a constant location in the lengthwise menu region 101 for easily returning to a former display state.

Accordingly, because the touch strips are used instead of function buttons for performing functions, the frame 11 can retain its neatness, regardless of how many functions the display apparatus has. Furthermore, since the surface areas of the touch sensitive strips can be designed in smaller sizes, the frame 11 of the display apparatus thereupon can be designed in a smaller size by using a narrow configuration, whereas the screen 10 thereof can be designed in a larger size, thereby the display apparatus may not only obtain a neater appearance but may also posses a larger screen for display more information. Moreover, due to the utilization of the two-dimensional touch strips and dynamic symmetric-type menus of the display apparatus, a user can easily select a desired menu option to perform the function associated therewith.

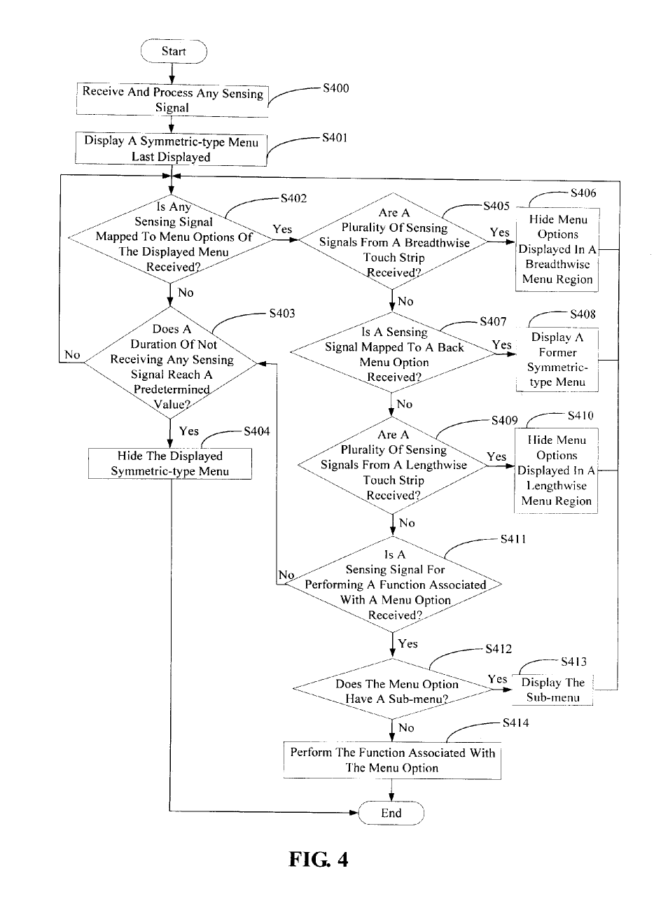

FIG. 4 is a flowchart of a preferred touch-based method for enabling a display apparatus of FIG. 1 to display the symmetric-type menu in accordance with a preferred embodiment of the present invention. In step S400, the processing unit 25 receives and processes any sensing signal from the touch sensitive units beneath the touch strips. In step S401, the processing unit 25 initiates the symmetric-type menu last displayed thereon in the menu regions to be displayed. That is, the processing unit respectively displays the menu and its associated sub-menu in the breadthwise menu region 100 and the lengthwise menu region 101.

In step S402, the processing unit 25 determines whether it receives any sensing signal mapped to the menu options of the displayed symmetric-type menu.

If the processing unit 25 does not receive a sensing signal mapped to the menu options of the displayed symmetric-type menu, in step S403, the processing unit 25 determines whether a duration of not receiving any sensing signal mapped to the menu options of the displayed symmetric-type menu reaches a predetermined value. If the duration reaches the predetermined value, in step S404, the processing unit 25 hides the symmetric-type menu displayed on the menu regions, and the procedure is finished. If the duration does not reach the predetermined value, the procedure returns to step S402.

If the processing unit 25 receives a sensing signal mapped to the menu options of the displayed symmetric-type menu, in step S405, the processing unit 25 determines whether it further receives a plurality of sensing signals from the breadthwise touch strip 110a. If received, in step S406, the processing unit 25 hides at least one of the menu options displayed in the breadthwise menu region 100 and replaces at least one of the displayed menu options by another hidden menu option, and further displays the sub-menu of the menu option which moves into the lengthwise menu region 101, and the procedure returns to step S402.

If not, in step S407, the processing unit determines whether it receives the sensing signal mapped to the “Back” menu option. If received, in step S408, the processing unit displays a former symmetric-type menu in the menu regions.

If not, in step S409, the processing unit 25 determines whether it receives a plurality of sensing signals from the lengthwise touch strip 110b. If received, in step S410, the processing unit 25 hides at least one of the menu options displayed in the lengthwise menu region 101 and replaces at least one of the displayed menu options by another hidden menu option, and the procedure returns to step S402.

If not, in step S411, the processing unit 25 determines whether it receives the sensing signal for performing the function associated with the menu options except the “Back” menu option from the lengthwise touch strip 110b. If not, the procedure returns to step S403.

If received, in step S412, the processing unit 25 determines whether the selected menu option has a sub-menu. If the selected menu option has a sub-menu, in step S413, the processing unit 25 displays the sub-menu of the selected menu option in the lengthwise menu region 101 and displays the menu including the selected menu option in the breadthwise menu region 100, and further displays the selected menu in the particular location 102 of the screen 10, and the procedure returns to step S402.

If the selected menu option doesn't have a sub-menu, in step S414, the processing unit 25 performs the function associated with the selected menu option, and the procedure is finished.

Although the present invention has been specifically described on the basis of the preferred embodiment and preferred method thereof, the invention is not to be construed as being limited thereto. Various changes or modifications may be made to the embodiment and method without departing from the scope and spirit of the invention.

What is claimed is:

1. A display apparatus capable of displaying a symmetric-type menu, the display apparatus comprising:
a screen having a breadthwise menu region and a lengthwise menu region respectively displaying a menu therein, wherein the menu in the lengthwise menu region is a sub-menu of a menu option of the menu in the breadthwise menu region; and
a frame connecting to the screen and having a breadthwise touch strip and a lengthwise touch strip, each touch strip allowing to select a desired menu option to perform an associated function therewith, and each touch strip mapped to a corresponding menu region.

2. The apparatus according to claim 1, wherein each touch strip comprises a plurality of touch sensitive units each mapped to a menu option.

3. The apparatus according to claim 2, wherein each touch sensitive unit further comprises a sensing signal processing circuit for generating sensing signals in response to contact, and each touch sensitive unit is assigned a coordinate for identification.

4. The apparatus according to claim 3, further comprising a processing unit for processing the sensing signals and performing corresponding functions associated with the menu options.

5. The apparatus according to claim 4, wherein the processing unit is configured to hide at least one of the menu options displayed in the breadthwise menu region, to replace at least one of the displayed menu options by another hidden menu option, and to display the sub-menu of the menu option which moves in the lengthwise menu region, in response to a stroke operation on the breadthwise touch strip.

6. The apparatus according to claim 5, wherein the processing unit is further configured to display the selected menu option in a particular location of the screen.

7. The apparatus according to claim 4, wherein the processing unit is configured to hide at least one of the menu options displayed in the lengthwise menu region and to replace at least one of the displayed menu options by another hidden menu option in response to a stroke operation on the lengthwise touch strip.

8. The apparatus according to claim 7, wherein the processing unit is configured to display a sub-menu of a selected menu option displayed in the lengthwise menu region in response to a touch operation on the lengthwise touch strip.

9. The apparatus according to claim 1, wherein a length of the lengthwise touch strip corresponds to a length of the lengthwise menu region, and a length of the breadthwise touch strip corresponds to a length of the breadthwise menu region.

10. A method for enabling a display apparatus to display a symmetric-type menu, the method comprising the steps of:
providing a display apparatus having a screen and a frame connecting to the screen, the screen having a breadthwise menu region and a lengthwise menu region, and the frame having a breadthwise touch strip and a lengthwise touch strip each mapped to a corresponding menu region;
receiving and processing any sensing signal from one of the touch strips;
displaying a symmetric-type menu in the menu regions;
hiding at least one of menu options displayed in the breadthwise menu region and replacing at least one of the displayed menu options by another hidden menu option and displaying a sub-menu of the menu option which moves in the lengthwise menu region, when receiving a plurality of sensing signals from the breadthwise touch strip;
hiding at least one of menu options displayed in the lengthwise menu region and replacing at least one of the displayed menu options by another hidden menu option when receiving a plurality of sensing signals from the lengthwise touch strip; and
performing a function associated with a selected menu option when receiving a sensing signal from the lengthwise touch strip.

11. The method according to claim 10, wherein the step of displaying a sub-menu of the menu option which moves in the lengthwise menu region further comprises the step of:
displaying the menu option which moves in the lengthwise menu in a particular location of the screen.

12. The method according to claim 11, wherein the step of performing a function associated with a selected menu option when receiving a sensing signal from the lengthwise touch strip further comprises the step of:
displaying a sub-menu of the selected menu option if the selected menu option has the sub-menu.

13. The method according to claim 12, wherein the sub-menu is displayed in the lengthwise menu region.

14. The method according to claim 10, further comprising the step of:
hiding the displayed symmetric-type when a duration of not receiving any sensing signal from any touch strip reaches a predetermined value.
